(19) United States
(12) Patent Application Publication
(10) Pub. No.: US 2013/0143045 A1
(43) Pub. Date: Jun. 6, 2013

(54) DEVICE HOUSING AND METHOD FOR MAKING THE SAME

(71) Applicants: SHU-XIANG ZHOU, Shenzhen City (CN); CHIA-WEN TSAO, Shindian (TW)

(72) Inventors: SHU-XIANG ZHOU, Shenzhen City (CN); CHIA-WEN TSAO, Shindian (TW)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/483,255

(22) Filed: May 30, 2012

(30) Foreign Application Priority Data
Dec. 2, 2011 (CN) 201110394704.8

(51) Int. Cl. B32B 27/06; B29C 39/20; B32B 27/38

(52) U.S. Cl. 428/413; 156/245

(57) ABSTRACT

A housing includes a substrate, a wood-grain material layer, and a protective layer. The wood-grain material layer is formed on the substrate and includes a wood-grain surface. The protective layer is formed on the wood-grain surface. The protective layer is made of transparent resin.

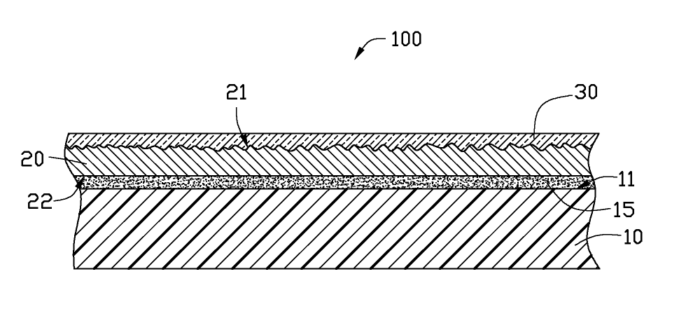

### BACKGROUND

1. Technical Field

The present disclosure relates to a device housing and a method for making the device housing.

2. Description of Related Art

Metallic shells are widely used in many technological fields. One example is a metallic shell used with a portable electronic device (e.g., a mobile phone) for shielding internal electronic components. Typically, exterior surfaces of metallic shells have an attractive smooth texture. However, the exterior surfaces of metallic shells can easily become abraded/worn and even damaged during daily use.

In another example, a wood-grain pattern is painted on the shell for getting a wood-grain appearance. However, the wood-grain appearance is not natural, and also easily becomes abraded/worn.

Therefore, there is room for improvement within the art.

### BRIEF DESCRIPTION OF THE FIGURE

Many aspects of the disclosure can be better understood with reference to the following FIGURE. The components in the FIGURE are not necessarily drawn to scale, the emphasis instead being placed upon clearly illustrating the principles of the disclosure.

The FIGURE is a cross-sectional view of an exemplary embodiment of a device housing.

### DETAILED DESCRIPTION

The FIGURE shows a portion of a housing 100 according to an exemplary embodiment. The housing 10 can be appropriately used with an electronic device, e.g. mobile phone, music player, computer and so on.

The housing 100 includes a substrate 10, a wood-grain material layer 20 formed on the substrate 10, and a protective layer 30 formed on the wood-grain material layer 20.

The substrate 10 is made of plastic and formed by injection molding. The plastic can be polycarbonate (PC), or polymethyl methacrylate (PMMA). The substrate 10 includes an exterior surface 11.

The wood-grain material layer 20 is made of natural wood. The wood-grain material layer 20 has a thickness of about 0.4 mm to about 0.6 mm. In this exemplary embodiment, the thickness of the wood-grain material layer 20 is 0.4 mm. The wood-grain material layer 20 includes a wood-grain surface 21 and a bottom surface 22. The bottom surface 22 of the wood-grain material layer 20 is adhered to the exterior surface 11 by adhesive 15.

The protective layer 30 is made of transparent thermosetting resin, for example, epoxy resin, phenolic resin, etc. The protective layer 30 is directly formed on the wood-grain material layer 20. A thickness of the protective layer 30 is in a range between 0.6 mm to 0.8 mm. In this exemplary embodiment, the thickness of the protective layer 30 is 0.8 mm. Because the protective layer 30 is transparent, the wood-grain material layer 20 can be observed through the protective layer 30. A deep wood-grain appearance will be presented.

A method for making the device housing 100 may include the following steps:

The substrate 10 is provided. The substrate 10 is ultrasonically cleaned using absolute ethyl alcohol for about 5 min-about 10 min.

The adhesive 15 is coated on the bottom surface 22 of the wood-grain material layer 20. Then, the bottom surface 22 is adhered to the external surface 11 of the substrate 10. Drying the adhesive 15 takes about 2 hours to about 4 hours.

Next, the protective layer 30 is formed on the wood-grain material layer 20 by a lower-pressure perfusion molding process. The substrate 10 with the wood-grain material layer 20 is placed into a mold cavity of a perfusion mold. Theremosetting liquid epoxy resin is fed into the mold cavity. A vacuum apparatus sucks air from the mold cavity for removing air in the liquid epoxy resin. The liquid epoxy resin covers the wood-grain material layer 20, and partially seeps into the wood-grain material layer 20, thereby strengthening the connection of the protective layer to the wood-grain material layer. The vacuum apparatus further helps the liquid epoxy resin to seep into the wood-grain material layer 20. In order to ensure the epoxy resin seeps into the wood-grain material layer 20, the liquid epoxy resin is kept in the mold cavity for at least about 30 minutes. Then, the liquid epoxy resin is heated to harden the epoxy resin on the wood-grain material layer 20 to form the protective layer 30. In this exemplary embodiment, the inside of the mold cavity is heated to about 60° C. to about 100° C. The heating time may last for about 40 minutes to about 60 minutes.

Finally, the substrate 10 with the protective layer 30 and the wood-grain material layer 20 is removed from the mold cavity. The wood-grain material layer 20 can be observed through the protective layer 30. A deep wood-grain appearance will be presented. Additionally, because the protective layer 30 is made of epoxy resin having a low thermal expansion rate, the hardening process of the epoxy resin will not deform the wood-grain material layer 20 and the substrate 10, achieving a more natural looking wood-grain appearance.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A housing comprising:
a substrate;
a wood-grain material layer formed on the substrate, the wood-grain material layer including a wood-grain surface; and
a protective layer formed on the wood-grain surface of the wood-grain material layer, the protective layer made of transparent resin.

2. The housing as claimed in claim 1, wherein the protective layer is made of thermosetting resin.

3. The housing as claimed in claim 2, wherein the protective layer is made of epoxy resin.

4. The housing as claimed in claim 1, wherein the wood-grain material layer includes a bottom surface opposite to the wood-grain surface, the bottom surface is adhered to the substrate by adhesive.

5. The housing as claimed in claim 1, wherein a portion of the protective layer seeps into the wood-grain material, thereby strengthening the connection of the protective layer to the wood-grain material layer.

6. A method for making a device housing, comprising:
providing a substrate and a wood-grain material layer;
adhering the wood-grain material layer on the substrate;
placing the substrate with the wood-grain material layer into a mold cavity of a perfusion mold;
feeding liquid resin to the mold cavity;
sucking air from the mold cavity by a vacuum apparatus;
hardening the liquid resin to form an transparent layer on the wood-grain material layer.

7. The method as claimed in claim 6, wherein the protective layer is made of epoxy resin.
